(19) United States
(12) Patent Application Publication
(10) Pub. No.: US 2013/0297421 A1
(43) Pub. Date: Nov. 7, 2013

(54) SYSTEM AND METHOD FOR ANALYSIS OF CUSTOMER INTERACTIONS TO DEVELOP COMPREHENSIVE CUSTOMER DATA ARCHIVES

(71) Applicants: Srinath Nagarajan, Charlotte, NC (US); Robert L. Abbott, Charlotte, NC (US); Matthew Laine Donlan, Charlotte, NC (US)

(72) Inventors: Srinath Nagarajan, Charlotte, NC (US); Robert L. Abbott, Charlotte, NC (US); Matthew Laine Donlan, Charlotte, NC (US)

(73) Assignee: Bank of America Corporation, Charlotte, NC (US)

(21) Appl. No.: 13/493,906

(22) Filed: Jun. 11, 2012

Related U.S. Application Data
(60) Provisional application No. 61/641,584, filed on May 2, 2012.
(60) Provisional application No. 61/641,700, filed on May 2, 2012.

(51) Int. Cl. G06Q 30/02

(52) U.S. Cl. 705/14.58; 705/14.66

(57) ABSTRACT

Embodiments of the invention are directed to systems, methods and computer program products for targeting offers to customers. Specifically, data relating to customers is gathered in order to generate a comprehensive customer data archive. The customer data archive may include transactional data and non-transactional data. Non-transactional data may include, for example, social media interactions, received input from a financial advisor, received input from the customer, customer-specific data such as age, family status, gender, etc.

### CROSS-REFERENCE TO RELATED APPLICATIONS

This application claims priority to U.S. Provisional Patent Application Ser. No. 61/641,700, filed May 2, 2012, entitled “Intelligent Offer Tool,” and U.S. Provisional Patent Application Ser. No. 61/641,584, filed May 2, 2012, entitled “System and Method for Analysis of Customer Interactions to Develop Comprehensive Customer Data Archives,” the entirety of each of which is incorporated herein by reference.

### BACKGROUND

When an entity sends a targeted offer to a potential customer, there is a greater likelihood that the potential customer will actually take advantage of the offer. By sending offers to potential customers who are more likely to use the offers and excluding those who will likely not use the offers, an entity can save a substantial amount of money and greatly enhance the effectiveness of the offers. Therefore, there is a need for a system to produce targeted purchase offers.

### BRIEF SUMMARY

Embodiments of the invention are directed to systems, methods and computer program products for targeting offers to customers. Specifically, data relating to customers is gathered in order to generate a comprehensive customer data archive. The customer data archive may include transactional data and non-transactional data. Non-transactional data may include, for example, social media interactions, received input from a financial advisor, received input from the customer, customer-specific data such as age, family status, gender, etc.

In one aspect of the invention, a method for creating a comprehensive customer data archive for associating offers is provided. The method includes receiving customer transaction data at a financial institution for a plurality of transactions by the customer over a period of time. The method additionally includes receiving non-transactional data relating to the customer. Furthermore, the method includes creating a customer data archive for associating offers comprising the transactional data and the non-transactional data. The method also includes storing the customer data archive in a database. In some embodiments of the method, the non-transactional data comprises at least one of social media interactions, received input from a financial advisor, received input from the customer, and other external sources. In some embodiments, the method further includes determining whether to transmit a targeted offer to the customer based at least in part on the customer data archive. In some such embodiments, the determining whether to transmit a targeted offer to the customer is based at least in part on transactional data indicative of financial health. In some embodiments, the method further includes determining to transmit a targeted offer for a particular merchant versus a targeted offer for a different merchant to the customer based at least in part on a pre-existing relationship determined between the customer and the particular merchant.

In another aspect of the invention, a method for transmitting a targeted offer to a customer is provided. The method includes creating a customer data archive for associating offers. The customer data archive includes transactional data and non-transactional data relating to a customer. Additionally, the method includes analyzing the customer data archive to determine if the customer meets desired characteristics for receiving a targeted offer. The method further includes determining whether the customer meets desired characteristics for receiving the targeted offer. Finally, the method includes presenting the targeted offer to the customer if the customer meets the desired characteristics. In some embodiments of the method, the non-transactional data comprises at least one of social media interactions, received input from a financial advisor, received input from the customer, and other external sources. In some embodiments of the method, the determining whether the customer meets desired characteristics for receiving the targeted offer is based at least in part on transactional data indicative of financial health. In some embodiments, the method further includes determining to transmit a targeted offer for a particular merchant versus a targeted offer for a different merchant to the customer based at least in part on a pre-existing relationship determined between the customer and the particular merchant.

In another aspect of the invention, a method for transmitting targeted offers to customers is provided. The method includes creating a customer data archive for associating offers. The customer data archive includes transactional data and non-transactional data relating to a customer. The method additionally includes receiving instructions from a third-party merchant for an advertising offer campaign. Furthermore, the method includes analyzing the customer data archive to determine if the customer meets desired characteristics for receiving a targeted offer from the advertising campaign of the third-party merchant. The method also includes presenting the targeted offer to the customer if the customer meets the desired characteristics. In some embodiments, the non-transactional data comprises at least one of social media interactions, received input from a financial advisor, received input from the customer, and other external sources.

In yet another aspect of the invention, an apparatus for transmitting a targeted offer to a customer is provided. The apparatus includes a memory, a processor, and a module stored in the memory and executable by the processor. The module is configured to create a customer data archive for associating offers comprising transactional data and non-transactional data relating to a customer. The module is further configured to analyze the customer data archive to determine if the customer meets desired characteristics for receiving a targeted offer. Additionally, the module is configured to determine whether the customer meets desired characteristics for receiving the targeted offer. The module is also configured to present the targeted offer to the customer if the customer meets the desired characteristics. In some embodiments, the non-transactional data comprises at least one of social media interactions, received input from a financial advisor, received input from the customer, and other external sources. In some embodiments of the apparatus, the determining whether the customer meets desired characteristics for receiving the targeted offer is based at least in part on transactional data indicative of financial health. In some embodiments, the module is further configured to transmit a targeted offer for a particular merchant versus a targeted offer for a different merchant to the customer based at least in part on a pre-existing relationship determined between the customer and the particular merchant.

In another aspect of the invention, a computer program product for transmitting a targeted offer to a customer. The computer program product includes a non-transitory computer-readable medium comprising a set of codes. The set of codes are configured to cause the computer to create a customer data archive for associating offers comprising transactional data and non-transactional data relating to a customer. The set of codes are further configured to analyze the customer data archive to determine if the customer meets desired characteristics for receiving a targeted offer. Additionally, the set of codes are further configured to determine whether the customer meets desired characteristics for receiving the targeted offer. Finally, the set of codes are configured to present the targeted offer to the customer if the customer meets the desired characteristics. In some embodiments of the product, the non-transactional data comprises at least one of social media interactions, received input from a financial advisor, received input from the customer, and other external sources. In some embodiments, the determining whether the customer meets desired characteristics for receiving the targeted offer is based at least in part on transactional data indicative of financial health. In some embodiments, the module is further configured to transmit a targeted offer for a particular merchant versus a targeted offer for a different merchant to the customer based at least in part on a pre-existing relationship determined between the customer and the particular merchant.

### BRIEF DESCRIPTION OF THE DRAWINGS

Having thus described embodiments of the invention in general terms, reference will now be made to the accompanying drawings, where:

FIG. 1 is a flowchart illustrating a general process flow for creating a customer data archive for associating offers, in accordance with embodiments of the present invention;

FIG. 2 is a flowchart illustrating various types of non-transactional data, in accordance with embodiments of the present invention;

FIG. 3 is a flowchart illustrating a general process flow for transmitting a targeted offer to a customer, in accordance with embodiments of the present invention; and

FIG. 4 is a flowchart illustrating a general process flow for transmitting a targeted offer to a customer, in accordance with embodiments of the present invention; and

FIG. 5 is a block diagram illustrating technical components of a system for implementing the various processes described herein, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for developing comprehensive customer Data Archives for associating offers. The customer data archive includes transactional data as well as non-transactional data. The comprehensive customer data archives enable an entity to transmit targeted offers to customers such that the targeted offers have a higher success rate of redemption from the customers.

In some embodiments, an “entity may” be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user data archive that includes only personal information associated with the user, etc. The account is associated with and/or maintained by the entity. In other embodiments, an entity may not be a financial institution. In still other embodiments, the entity may be the merchant itself.

In some embodiments, the “user” may be a customer (e.g., an account holder or a person who has an account (e.g., banking account, credit account, etc.) at the entity) or potential customer (e.g., a person who has submitted an application for an account, a person who is the target of marketing materials that are distributed by the entity, a person who applies for a loan that not yet been funded).

As an example, an entity (e.g., a financial institution) may send an offer to a user (e.g., an account holder). The offer may be presented the user via at least one of the user's electronic banking account (e.g., online banking account, mobile banking account, etc.), the user's social network account, email, or text message. In some embodiments, the user may select an option associated with the presented offer to accept the offer. When the user accepts the offer, the offer is activated so that if the user uses an eligible payment method (as determined by the entity or the merchant) to make a purchase associated with the offer, the user receives the benefit associated with the offer. In other embodiments, the offer may be automatically activated if the user has previously chosen to automatically activate offers associated with particular types (e.g., associated with particular merchants or product or service types). In some embodiments, the entity or the merchant may determine that a user may choose among multiple eligible payment methods in order to make a purchase associated with the offer.

As merely an example, the targeted offer may be a rebate of $5 on a purchase of $20 from a merchant. The user may decide to use the offer by visiting the merchant and making a purchase of $20. In some embodiments, at the point of sale, the user pays $20 for the user's purchase using an eligible payment method determined by the financial institution or the merchant (e.g., payment card, mobile device payment, check, etc.). In some embodiments, when the transaction is processed by the financial institution at a predetermined time in the future (e.g., as part of a periodic batch processing operation), the financial institution provides a rebate of $5 to the user's financial institution account. In such embodiments, the merchant, at the point of sale, may have no knowledge that the user will receive a rebate at some point in the future. In other embodiments, even the user may not be aware of the rebate at the point of sale (e.g., if the offer was automatically activated). In still further embodiments, the point of sale terminal may provide an indication to at least one of the merchant or the user that the user will receive a rebate at some point in the future. In some embodiments, the targeted offer may be a more traditional-type offer such as an offer presented to the customer prior to purchase and the offer is redeemed by the merchant.

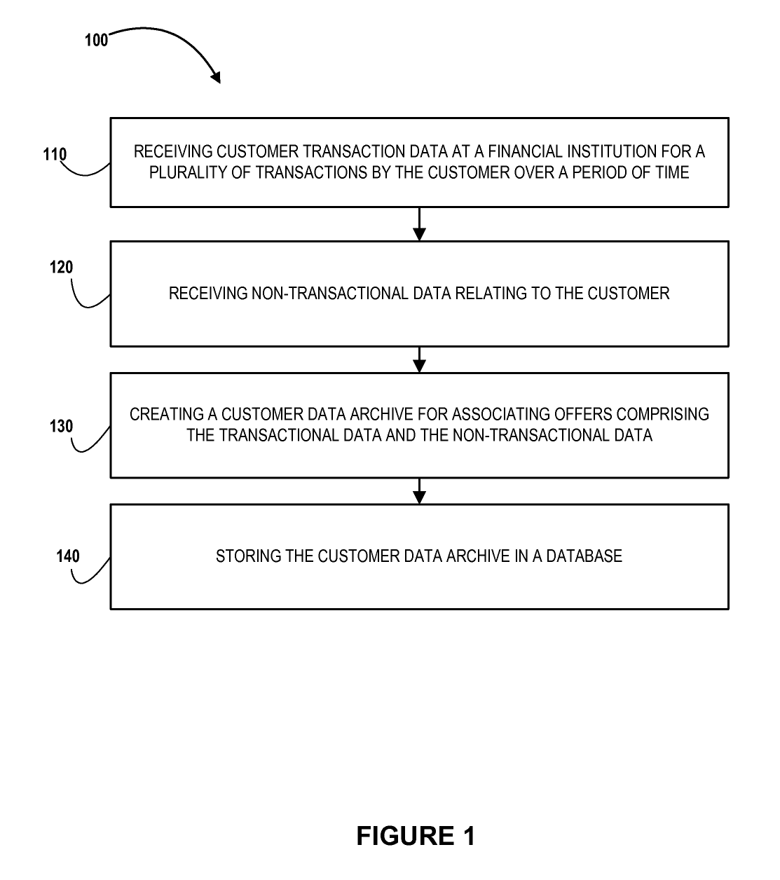

Referring now to FIG. 1, a general process flow 100 is provided for creating a customer data archive for associating offers. At block 110, the method includes receiving customer transaction data at a financial institution for a plurality of transactions by the customer over a period of time. At block 120, the method further includes receiving non-transactional data relating to the customer. Moving to block 130, the method comprises creating a customer data archive for associating offers. The customer data archive includes both transactional and non-transactional data. Once the customer data archive is created, the data archive is stored in a database, as indicated in block 140.

Transactional data comprises any data related to the customer's transaction history associated with the financial institution account. The transaction history includes the types of transactions, frequency of transactions, amount of each transaction, merchants associated with transactions, account balance history, etc. Additionally or alternatively, the account information may or may not comprise information associated with incorrect, inconsistent, incomplete, or corrupted transactions. As used herein, a transaction may comprise a purchase, a deposit, a withdrawal, a credit, a debit, etc.

The transactional data may be utilized in any desirable manner. For instance, a particular period of time may be important for offer triggering (e.g., transaction data indicates that more gasoline is utilized by the customer in the summer as opposed to the winter). In some embodiments, the customer's entire account history of transaction data may be utilized in the customer data archive. In other embodiments, only a particular window of transactions may be utilized. In some embodiments, the previous month of transaction data, in some embodiments, the previous one to six months of transaction data, in some embodiments, six to twelve months of transaction data, in some embodiments thirteen months of transaction data, and in some embodiments one to two years of transaction data is utilized. Again, any amount from one day to the entire account history of transaction data may be utilized in the comprehensive customer data archive.

Utilization of transactional data may provide unique information to generate targeted offers. For example, transactional data may indicate a customer's daily preference for a certain type of product, such as coffee. In some embodiments, a targeted offer may be triggered for a coffee establishment that the customer frequents often. In other embodiments, a targeted offer may be triggered for a competitor merchant coffee establishment which the customer does not frequent often, if at all. In some embodiments, the triggered offer may more indirectly relate to the transactional data. For instance, utilizing the coffee example, the transactional data seems to indicate the customer has a preference for caffeine in the morning. Thus, rather than a coffee offer triggered, possibly an energy drink offer, high in caffeine, may be triggered.

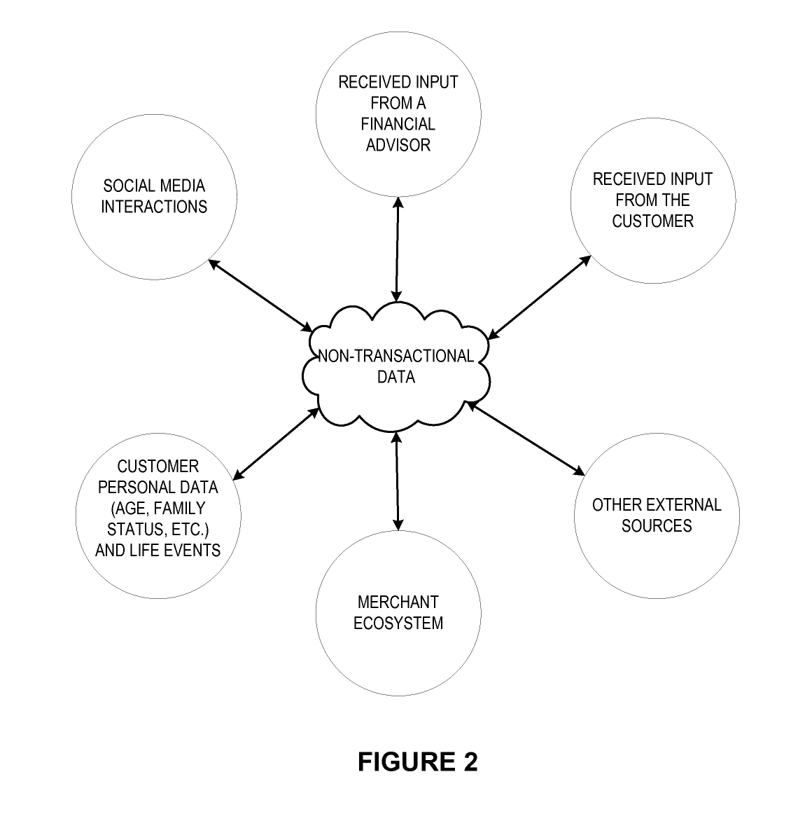

Non-transactional data may be gathered from any number of sources. FIG. 2 illustrates various types of non-transactional data contemplated herein. As illustrated, non-transactional data may include input from a financial advisor, input from the customer, social media interactions, customer personal data such as age, family status, etc., customer life events, or any other external source.

One embodiment of non-transactional data includes data inputted by a financial advisor that may be gleaned from other information known to the financial institution. For instance, the financial institution may have direct knowledge of a customer with investment accounts for children, joint accounts with spouse, etc. From that information, the number of family members, potentially birthdays of those in the family, etc. may be deduced. Of course, a financial advisor may input any type of data obtained directly from the customer if the customer consents to provide the information for generation of the customer data archive. Any information inputted into the financial institution system by the financial advisor for addition to the customer's comprehensive data archive may result in various triggered offers.

Of course, input from the customer may also be included in non-transactional data. In some embodiments, the customer may actively seek certain offers. As such, a customer could potentially trigger an offer simply by asking for it. In other embodiments, the offer triggering based at least in part on customer input may be more indirect. For instance, the customer may input a child's birthday which triggers an offer for a cake product a week prior to the child's birthday. As another example, the customer may travel away from home and input the destination he is travelling to in order to generate location-based offers away from home.

Determining a customer “merchant ecosystem” is another type of non-transactional data that may be incorporated into the customer data archive. The merchant ecosystem is essentially a determination of what merchants customers visit; interact with, etc. in order to determine merchant patterns. The merchant ecosystem data may be gathered, for instance, by determining what merchant websites a customer may visit, social media data collection (discussed below), etc.

Another type of non-transactional data may be social media interactions. With the sharp rise in social media usage, a customer's social media interactions may be indicative of the customer's preferences—maybe even more so than transactional data. Examples of a customer's social media interactions include “liking” certain merchants on social media platforms, interaction with merchants, interaction with peers discussing particular products or merchants, etc.

Customer personal data may be another form of non-transactional data that may be useful in generating the customer's data archive. Personal data may be as simple as the customer's birthday, address, relationship with other financial institution customers, etc. which could have been obtained upon account generation at the financial institution or gathered by other means over time. A type of personal data may include various life events of the customer. Life events could include any significant event in the customer's life. Examples may include marriage, divorce, birth of a child, relocation, vacation, child's graduation, etc.

Utilizing transactional data with non-transactional data may provide unique benefits in targeting offers. For instance, non-transactional data may indicate that a customer frequents a particular book store, but transactional data does not indicate that the customer purchases from the book store. Rather, transactional data may indicate that the customer purchases from a discount online book store. Thus, such comparison of transactional data and non-transactional data may serve to trigger a particular offer for the book store.

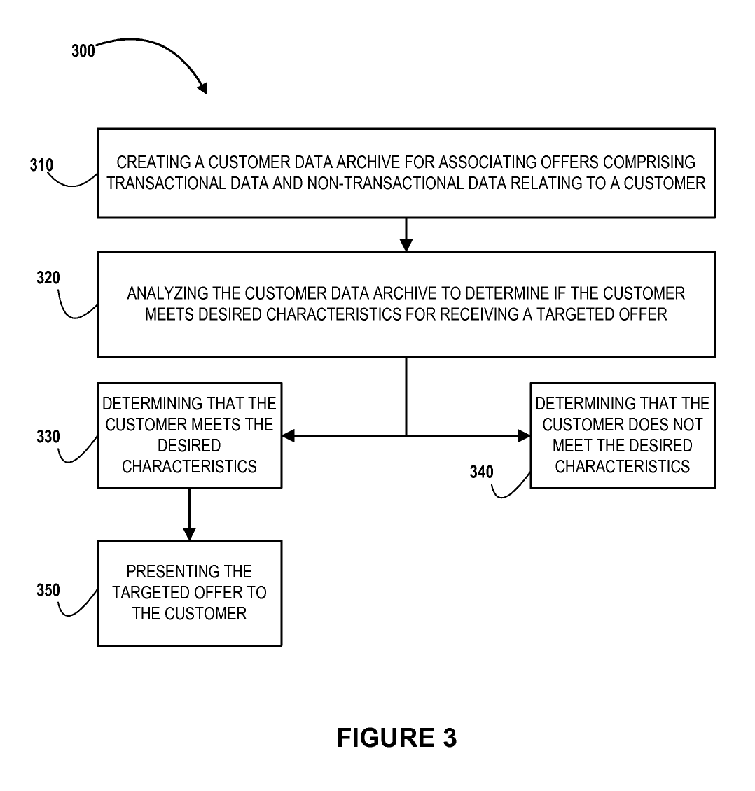

Turning now to FIG. 3, a general process flow 300 is provided for transmitting a targeted offer to a customer. As illustrated at block 310, the method includes creating a customer data archive for associating offers comprising transactional data and non-transactional data relating to a customer. Once the data archive is created, the method 300 progresses to block 320 where the customer data archive is analyzed to determine if the customer meets desired characteristics for receiving a targeted offer.

The desired characteristics may be any particular trait or tendency of the customer as indicated by the data archive. For example, transaction data may indicate an increased frequency in charges at auto repair shops and rental cars while the customer does not make payments on a vehicle (i.e., vehicle presumed to be paid off and likely an older model vehicle). Such characteristics may trigger an offer for a new car, an auto repair shop, a rental car company, etc.

In some embodiments, a particular offer may be triggered based at least in part on perceived financial health of the customer. In one embodiment, an offer may be triggered for perceived good financial health due to on-time payments, maintained minimum balances, etc. In another embodiment, certain offers may be triggered for a perceived reduction in financial health.

In some embodiments, the financial institution may have a database of pending offers from a plurality of merchants which may be transmitted to customers upon triggering. The database may, of course, have various settings which the system administrator may readily alter. For instance, it may be desirable to restrict the number of offer transmissions to a customer so that some customers that happen to trigger many offers do not get inundated with continuous offers. In such a case, the offers that have the highest likelihood of success or “best match” to the customer may be transmitted over other offers.

In some embodiments, it may be desirable to incentivize customers with offers for certain merchants over others. For instance, a merchant's advertising campaign may be directed to targeting offers to customers that frequent a competitor. In another embodiment, if multiple similar offers are triggered for different merchants, the financial institution may prefer to transmit the offer of one merchant over that of another. The financial institution may have any number of reasons for preferring the offer of one merchant over another. Some examples may include that one merchant is a customer of the financial institution and the other is not, one merchant may pay the financial institution a premium to have preference when competing offers are triggered, the financial institution may determine that one offer has a higher likelihood of success over another offer, one offer may be thought to generate more transactions than another offer, etc. As such, in some embodiments, the targeted offers may serve as a means to incentivize purchases from certain merchants or influence the customer's buying habits.

In some embodiments, the financial institution may gather transactional data on a product level which may trigger offers for other related products. For example, transactional data may indicate that a customer recently purchased a kitchen appliance such as a stove. Such data may aid in triggering an offer for other kitchen appliances such as a refrigerator, microwave, dishwasher, etc.

Once the customer data archive has been analyzed to determine if the customer meets desired characteristics for receiving a targeted offer, the process 300 advances to block 330 if it is determined that the customer meets the desired characteristics or to block 340 if it is determined that the customer does not meet the desired characteristics. If the customer does not meet the desired characteristics, the process may either end or revert back to the previous step 320 to determine if the customer meets desired characteristics of another offer. If the customer meets the desired characteristics, the process advances to block 350 and the targeted offer is transmitted to the customer.

The offers may be transmitted to the customer by any means such as mail, e-mail, SMS message, loading the offer to a mobile device application, via a webpage interface such as the financial institution or the merchant webpage, loaded to a loyalty card, loaded to a debit/credit card or otherwise associated with the account such that the offer may be automatically redeemed at the point of sale or rebated after the sale, television, vehicle communication device, etc.

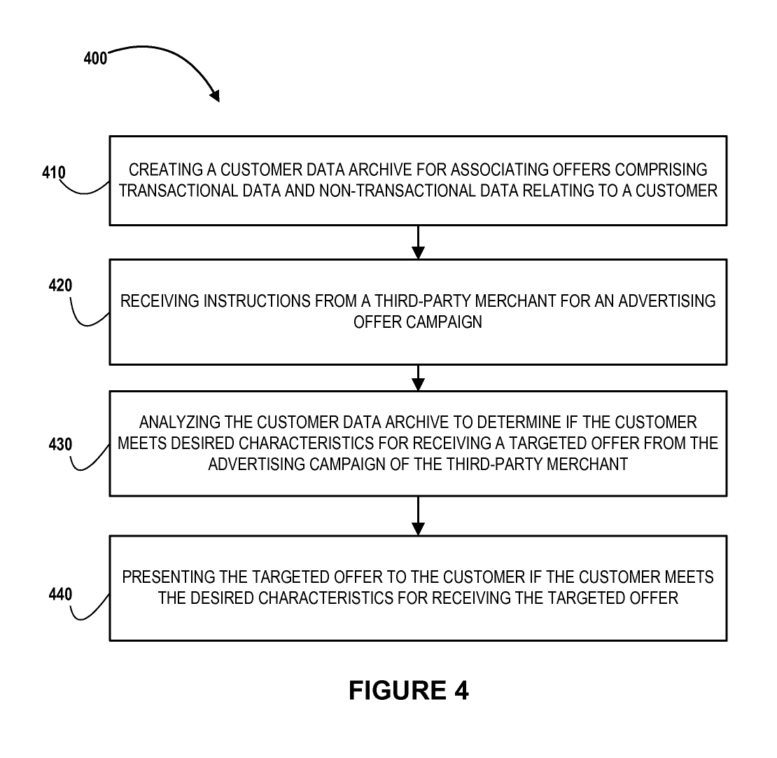

FIG. 4 illustrates another process flow 400 for transmitting a targeted offer to a customer. As illustrated at block 410, the method includes creating a customer data archive for associating offers comprising transactional data and non-transactional data relating to a customer. The method 400 further includes block 420 where the financial institution may receive instructions from a third-party merchant for an advertising offer campaign.

The instructions received from the third-party merchant may be by any means and of any structure. In some embodiments, a third-party merchant simply transmits the offer to the financial institution with general instructions to transmit the offer to various customers as the financial institution sees fit based, for example, on a “best match” system. In some cases, the third-party merchant may wish to transmit a limited number of offers only to a select group of customers. In other embodiments, the instructions may be more specific to target a particular customer trait or tendency. In still further embodiments, the financial institution may solicit the offer from the third-party merchant. For example, the financial institution may indicate that certain number of customers meet a particular criterion and indicate that the third-party merchant may benefit from conducting a targeted offer campaign through the financial institution.

In some instances, it may be beneficial to incorporate location data into the customer data archive. Location data may be a general “home” location of the customer or may be real-time location data from, for example, a mobile device of the customer. In some embodiments, non-transactional data may include data that the offer had been selected by the customer as an offer of interest to the customer as described in U.S. Provisional Application No. 61/641,700. Other data, such as location for instance, may be utilized to alert the customer again to the already selected offer.

Once instructions have been received, the process advances to block 430 where the customer data archive is analyzed to determine if the customer meets desired characteristics for receiving the targeted offer from the advertising campaign of the third-party merchant. Again, depending on the campaign, the offer may be transmitted to every customer that meets the criteria or there may be a limited number of offers to transmit to the “best match” customers.

Next, the process moves to block 440 where the targeted offer from the third-party merchant campaign is presented to a customer that meets the desired characteristics. Again, the offer may be transmitted by any suitable means. In one embodiment, the offer transmitted may have a “shelf life” such that the offer must be accepted within a certain time period. Furthermore, the offer may be a “vanishing” offer such that the savings may diminish over time until the offer disappears encouraging early acceptance of the offer.

Of note, in some embodiments, it may be desired to maintain a separate database or continuously update the customer data archive to reflect the offers transmitted, the rate of offer acceptance, the rate of opting out of the targeted offer program, the rate of opting in to the targeted offer program, the rate of offers activated or redeemed by customers, etc. Such data may be beneficial (and serve as non-transactional data) to improve targeted offers in the future. Indeed, such data may readily indicate the types of offers that are successful versus the types of offers that are unsuccessful. Additionally, other pattern data may be monitored such as patterns based on the time of the year, time of the day the offer was transmitted, location of the customer, etc.

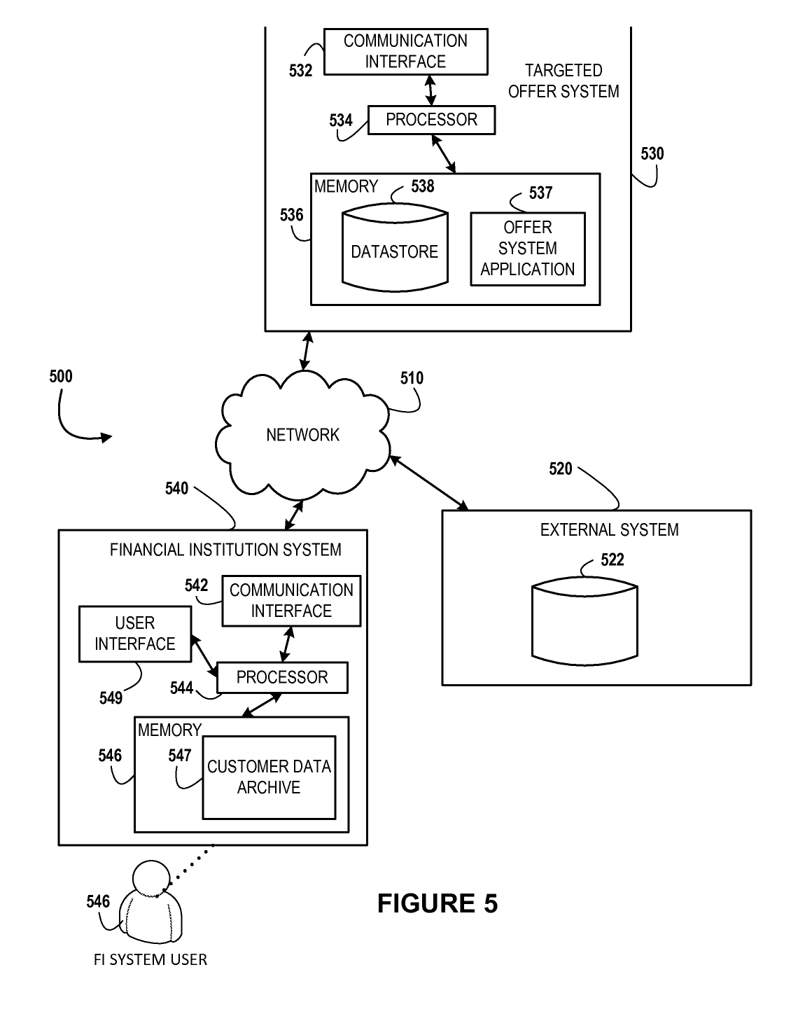

Referring now to FIG. 5, FIG. 5 presents an exemplary block diagram of a system environment 500 that may be useful for implementing the process flows 100, 300, and 400, described in FIGS. 1, 3, and 4, in accordance with embodiments of the present invention. As illustrated, the system environment 500 includes a network 510, an external system 520, a targeted offer system 530, and a financial institution system 540. Also shown in FIG. 5 is a financial institution user 545 of the financial institution system 540. The user 545 may be a person who uses the financial institution system 540 to access customer data archives 547 or uses the financial institution system 540 to initiate execution of the offer system application 537. The user 545 may be an employee of the entity that manages the targeted offer system 530 and/or the external system 520. In other embodiments, the user 545 may not be an employee of an entity, but may still provide a service under the direction and/or supervision of the entity.

As shown in FIG. 5, the external system 520, the targeted offer system 530, and the financial institution system 540 are each operatively and selectively connected to the network 510, which may include one or more separate networks. In addition, the network 510 may include a local area network (LAN), a wide area network (WAN), and/or a global area network (GAN), such as the Internet. It will also be understood that the network 510 may be secure and/or unsecure and may also include wireless and/or wireline and/or optical interconnection technology.

The external system 520 may be any computing or non-computing system that transmits information to the targeted offer system 530 or the financial institution system 540. Additionally or alternatively, information from the system 530 may be transmitted to the external system 520. As presented in FIG. 5, the external system 520 comprises at least one datastore 522. The datastore 522 may comprise information relating to at least one of the user, the user's financial institution account, offers, rules related to targeting offers to users, personal information, etc. As used herein, the terms “data” and “information” may be used interchangeably.

The financial institution system 540 may include any computerized apparatus that can be configured to perform any one or more of the functions of the financial institution system 540 described and/or contemplated herein. For example, the user 545 may use the financial institution system 540 to transmit information to the targeted offer system 530. In some embodiments, for example, the financial institution system 540 may include a personal computer system, a mobile computing device, a personal digital assistant, a network device, and/or the like. As illustrated in FIG. 5, in accordance with some embodiments of the present invention, the financial institution system 540 includes a communication interface 542, a processor 544, a memory 546 which may store customer data archives 547, and a user interface 549. In such embodiments, the communication interface 542 is operatively and selectively connected to the processor 544, which is operatively and selectively connected to the user interface 549 and the memory 546. In some embodiments, the user 545 may use the financial institution system 540 to execute processes described with respect to the process flows described herein, or may initiate the targeted offer system 530 to execute the process flows described herein.

Each communication interface described herein, including the communication interface 542, generally includes hardware, and, in some instances, software, that enables the financial institution system 540, to transport, send, receive, and/or otherwise communicate information to and/or from the communication interface of one or more other systems on the network 510. For example, the communication interface 542 of the financial institution system 540 may include a modem, server, electrical connection, and/or other electronic device that operatively connects the financial institution system 540 to another system such as the targeted offer system 530.

Each processor described herein, including the processor 544, generally includes circuitry for implementing the audio, visual, and/or logic functions of the financial institution system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device.

Each memory device described herein, including the memory 546 for storing the customer data archives 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the customer data archives 547. In some embodiments, the customer data archives 547 are accessible by an application that includes an interface for communicating with, navigating, controlling, configuring, and/or using at least one of the targeted offer system 530 or the financial institution system 540. In some embodiments, the application that may access the customer data archives 537 includes computer-executable program code portions for instructing the processor 544 to perform one or more of the functions of the application described and/or contemplated herein. In some embodiments, the application may include and/or use one or more network and/or system communication protocols.

Also shown in FIG. 5 is the user interface 549. In some embodiments, the user interface 549 includes one or more output devices, such as a display and/or speaker, for presenting information to the user 545. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 545. In some embodiments, the user interface 549 includes the input and display devices of a personal computer, such as a keyboard and monitor, which are operable to receive and display information.

FIG. 5 also illustrates a targeted offer system 530, in accordance with an embodiment of the present invention. The targeted offer system 530 may include any computerized apparatus that can be configured to perform any one or more of the functions of the targeted offer system 530 described and/or contemplated herein. In accordance with some embodiments, for example, the targeted offer system 530 may include a computer network, an engine, a platform, a server, a database system, a front end system, a back end system, a personal computer system, and/or the like. In some embodiments, such as the one illustrated in FIG. 5, the targeted offer system 530 includes a communication interface 532, a processor 534, and a memory 536, which includes an offer system application 537 and a datastore 538 stored therein. As shown, the communication interface 532 is operatively and selectively connected to the processor 534, which is operatively and selectively connected to the memory 536.

It will be understood that the offer system application 537 may be configured to implement any one or more portions of the various user interfaces and/or process flow described herein. It will also be understood that, in some embodiments, the memory includes other applications. It will also be understood that, in some embodiments, the offer system application 537 is configured to communicate with the datastore 538, the financial institution system 540 and/or the external system 520.

It will be further understood that, in some embodiments, the offer system application 537 includes computer-executable program code portions for instructing the processor 534 to perform any one or more of the functions of the offer system application 537 described and/or contemplated herein. In some embodiments, the offer system application 537 may include and/or use one or more network and/or system communication protocols.

In addition to the offer system application 537, the memory 536 also includes the datastore 538. As used herein, the datastore 538 may be one or more distinct and/or remote datastores. In some embodiments, the datastore 538 is not located within the system and is instead located remotely from the system. In some embodiments, the datastore 538 stores information or data described herein. For example, the datastore 538 may store information relating to at least one of the user, the user's financial institution account, offers, rules related to targeting offers to users, personal information, etc.

It will be understood that the datastore 538 may include any one or more storage devices, including, but not limited to, datastores, databases, and/or any of the other storage devices typically associated with a computer system. It will also be understood that the datastore 538 may store information in any known way, such as, for example, by using one or more computer codes and/or languages, alphanumeric character strings, data sets, figures, tables, charts, links, documents, and/or the like. Further, in some embodiments, the datastore 538 may include information associated with one or more applications, such as, for example, the offer system application 537. It will also be understood that, in some embodiments, the datastore 538 provides a substantially real-time representation of the information stored therein, so that, for example, when the processor 534 accesses the datastore 538, the information stored therein is current or substantially current.

It will be understood that the embodiment of the system environment illustrated in FIG. 5 is exemplary and that other embodiments may vary. As another example, in some embodiments, the targeted offer system 530 includes more, less, or different components. As another example, in some embodiments, some or all of the portions of the system environment 500 may be combined into a single portion. Likewise, in some embodiments, some or all of the portions of the targeted offer system 530 may be separated into two or more distinct portions.

In addition, the various portions of the system environment 500 may be maintained for and/or by the same or separate parties. For example, the targeted offer system 530 and the external system 520 may be maintained by separate parties.

It will also be understood that the targeted offer system 530 may include and/or implement any embodiment of the present invention described and/or contemplated herein. For example, in some embodiments, the targeted offer system 530 is configured to implement any one or more of the embodiments of the process flow 100, 300, 400 described and/or contemplated herein in connection with FIGS. 1, 3, and 4, or any other process flow described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for transmitting a targeted offer to a customer, the system comprising:
a memory;
a processor; and
a module stored in the memory, executable by the processor, and configured to:
receive customer transaction data at a financial institution for a plurality of transactions by the customer over a period of time;
receiving non-transactional data relating to the customer;
create a customer data archive for associating offers comprising the transactional data and the non-transactional data;
analyze the customer data archive to determine if the customer meets desired characteristics for receiving a targeted offer;
determine whether the customer meets desired characteristics for receiving the targeted offer; and
present the targeted offer to the customer if the customer meets the desired characteristics.

2. The system of claim 1, wherein the non-transactional data comprises at least one of social media interactions, received input from a financial advisor, received input from the customer, and other external sources.

3. The system of claim 1, wherein determining whether the customer meets desired characteristics for receiving the targeted offer is based at least in part on transactional data indicative of financial health.

4. The system of claim 1, wherein the module is further configured to transmit a targeted offer for a particular merchant versus a targeted offer for a different merchant to the customer based at least in part on a pre-existing relationship determined between the customer and the particular merchant.

5. The system of claim 1, wherein the module is further configured to receive instructions from a third-party merchant for an advertising offer campaign comprising instructions for analyzing the customer data archive to determine if the customer meets the desired characteristics.

6. The system of claim 1, wherein the non-transactional data comprises location data.

7. A method for transmitting a targeted offer to a customer, the method comprising:
receiving customer transaction data at a financial institution for a plurality of transactions by the customer over a period of time;
receiving non-transactional data relating to the customer;
creating a customer data archive for associating offers comprising the transactional data and the non-transactional data;
storing the customer data archive in a database;
analyzing the customer data archive to determine if the customer meets desired characteristics for receiving a targeted offer;
determining whether the customer meets desired characteristics for receiving the targeted offer; and
presenting the targeted offer to the customer if the customer meets the desired characteristics.

8. The method of claim 7, wherein the non-transactional data comprises at least one of social media interactions, received input from a financial advisor, received input from the customer, and other external sources.

9. The method of claim 7, wherein the determining whether the customer meets desired characteristics for receiving the targeted offer is based at least in part on transactional data indicative of financial health.

10. The method of claim 7, further comprising determining to transmit a targeted offer for a particular merchant versus a targeted offer for a different merchant to the customer based at least in part on a pre-existing relationship determined between the customer and the particular merchant.

11. The method of claim 7, further comprising receiving instructions from a third-party merchant for an advertising offer campaign comprising instructions for analyzing the customer data archive to determine if the customer meets the desired characteristics.

12. The method of claim 7, wherein the non-transactional data comprises location data.

13. A computer program product for transmitting a targeted offer to a customer, the computer program product comprising:
a non-transitory computer-readable medium comprising a set of codes for causing a computer to:
receive customer transaction data at a financial institution for a plurality of transactions by the customer over a period of time;
receiving non-transactional data relating to the customer;
create a customer data archive for associating offers comprising the transactional data and the non-transactional data;
analyze the customer data archive to determine if the customer meets desired characteristics for receiving a targeted offer;
determine whether the customer meets desired characteristics for receiving the targeted offer; and
present the targeted offer to the customer if the customer meets the desired characteristics.

14. The computer program product of claim 13, wherein the non-transactional data comprises at least one of social media interactions, received input from a financial advisor, received input from the customer, and other external sources.

15. The computer program product of claim 13, wherein determining whether the customer meets desired characteristics for receiving the targeted offer is based at least in part on transactional data indicative of financial health.

16. The computer program product of claim 13, wherein the module is further configured to transmit a targeted offer for a particular merchant versus a targeted offer for a different merchant to the customer based at least in part on a pre-existing relationship determined between the customer and the particular merchant.

17. The computer program product of claim 13, wherein the module is further configured to receive instructions from a third-party merchant for an advertising offer campaign comprising instructions for analyzing the customer data archive to determine if the customer meets the desired characteristics.

18. The computer program product of claim 13, wherein the non-transactional data comprises location data.
